(19) United States
(12) Patent Application Publication
(10) Pub. No.: US 2013/0162547 A1
(43) Pub. Date: Jun. 27, 2013

(54) TOUCH SCREEN

(71) Applicants: Dong Sik Yoo, Gyunggi-do (KR); Kyoung Soo Chae, Gyunggi-do (KR)

(72) Inventors: Dong Sik Yoo, Gyunggi-do (KR); Kyoung Soo Chae, Gyunggi-do (KR)

(73) Assignee: SAMSUNG ELECTRO-MECHANICS CO., LTD., Gyunggi-do (KR)

(21) Appl. No.: 13/439,670

(22) Filed: Apr. 4, 2012

(30) Foreign Application Priority Data
Dec. 27, 2011 (KR) 1020110143607

(51) Int. Cl. G06F 3/041

(52) U.S. Cl. 345/173

(57) ABSTRACT

Disclosed herein is a touch screen. The touch screen according to a preferred embodiment of the present invention includes a transparent substrate; a touch electrode formed on one surface of the transparent substrate; a digitizer electrode formed on the other surface of the transparent substrate; and an image display device provided in the other surface direction of the transparent substrate.

### CROSS REFERENCE TO RELATED APPLICATION

This application claims the benefit of Korean Patent Application No. 10-2011-0143607, filed on Dec. 27, 2011, entitled “Touch Screen”, which is hereby incorporated by reference in its entirety into this application.

### BACKGROUND OF THE INVENTION

1. Technical Field

The present invention relates to a touch screen.

2. Description of the Related Art

With the development of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has been widening the use of computers more and more, it is difficult to efficiently operate products using only a keyboard and mouse currently serving as an input device. Therefore, the necessity for a device that is simple, has minimal malfunction, and is capable of easily inputting information has increased.

In addition, current techniques for input devices have progressed toward techniques related to high reliability, durability, innovation, designing and processing beyond the level of satisfying general functions. To this end, a touch screen has been developed as an input device capable of inputting information such as text, graphics, or the like.

This touch screen is mounted on a display surface of an image display device such as an electronic organizer, a flat panel display device including a liquid crystal display (LCD) device, a plasma display panel (PDP), an electroluminescence (EL) element, or the like, or a cathode ray tube (CRT) to thereby be used to allow a user to select desired information while viewing the image display device.

Meanwhile, a type of a touch sensor for the touch screen is classified into a resistive type, a capacitive type, an electromagnetic type, a surface acoustic wave (SAW) type, and an infrared type. These various types of touch screens are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch screen and the capacitive type touch screen have been prominently used in a wide range of fields.

In addition, a digitizer sensor of the touch screen has adopted an electromagnetic induction scheme. Here, the digitizer sensor may derive writing pressure or accurate coordinates and apply the derived writing pressure or accurate coordinates to a screen, which results in being advantageously used for functions such as drawing or writing using a pen, or the like.

However, in the touch device of the prior art, the digitizer sensor is disposed on a back surface of a display surface of an image display device, thereby degrading touch sensitivity when touching a pen in a front direction of the display surface of the image display device.

### SUMMARY OF THE INVENTION

The present invention has been made an effort to provide a touch screen in which a touch electrode and a digitizer electrode are configured in a single module.

In addition, the present invention has been made in an effort to provide a touch screen in which a touch electrode and a digitizer electrode are disposed on a front of an image display device.

Further, the present invention has been made in an effort to provide a touch screen in which a touch electrode and a digitizer electrode are disposed on a single surface.

According to a preferred embodiment of the present invention, there is provided a touch screen, including: a transparent substrate; a touch electrode formed on one surface of the transparent substrate; a digitizer electrode formed on the other surface of the transparent substrate; and an image display device provided in the other surface direction of the transparent substrate.

The touch electrode may include first electrode patterns and second electrode patterns.

The digitizer electrode may include third electrode patterns and fourth electrode patterns.

The touch electrode may be made of copper (Cu), aluminum (Al), gold (Au), silver (Ag), titanium (Ti), palladium (Pd), chromium (Cr), or a combination thereof.

The touch electrode may be formed in a mesh form.

The touch electrode may be made of poly-3,4-ethylenedioxythiophene/polystyrenesulfonate (PEDOT/PSS), polyaniline, polyacetylene, or polyphenylenevinylene.

The touch electrode may be made of metal silver formed by exposing and developing a silver salt emulsion layer.

The touch electrode may be made of indium-thin oxide.

According to another preferred embodiment of the present invention, there is provided a touch screen, including: a transparent subs ate; a touch electrode formed on a first side of one surface of the transparent substrate; a digitizer electrode formed on a second side of one surface of the transparent substrate; and an image display device provided in the other surface direction of the transparent substrate.

The touch electrode may include first electrode patterns and second electrode patterns.

The digitizer electrode may include third electrode patterns and fourth electrode patterns.

The third electrode patterns and the fourth electrode patterns may be each formed along edges of the first electrode patterns and the second electrode patterns.

The touch electrode may be made of copper (Cu), aluminum (Al), gold (Au), silver (Ag), titanium (Ti), palladium (Pd), chromium (Cr), or a combination thereof.

The touch electrode may be formed in a mesh form.

The touch electrode may be made of poly-3,4-ethylenedioxythiophene/polystyrenesulfonate (PEDOT/PSS), polyaniline, polyacetylene, or polyphenylenevinylene.

The touch electrode is made of metal silver formed by exposing and developing a silver salt emulsion layer.

The touch electrode may be made of indium-thin oxide.

### BRIEF DESCRIPTION OF THE DRAWINGS

FIG. 1 is an exploded perspective view of a touch screen according to a first preferred embodiment of the present invention;

FIG. 2 is a cross-sectional view of the touch screen according to the first preferred embodiment of the present invention;

FIG. 3 is an exploded perspective view of a touch screen according to a second preferred embodiment of the present invention;

FIG. 4 is a cross-sectional view of a touch screen according to a second preferred embodiment of the present invention; and

FIG. 5 is a plan view showing a configuration example of a touch electrode and a digitizer electrode of the touch screen according to the second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms.

Further, in describing the present invention, a detailed description of related known functions or configurations will be omitted so as not to obscure the subject of the present invention.

Hereinafter, preferred embodiments of the present invention will be described in detail with reference to the accompanying drawings.

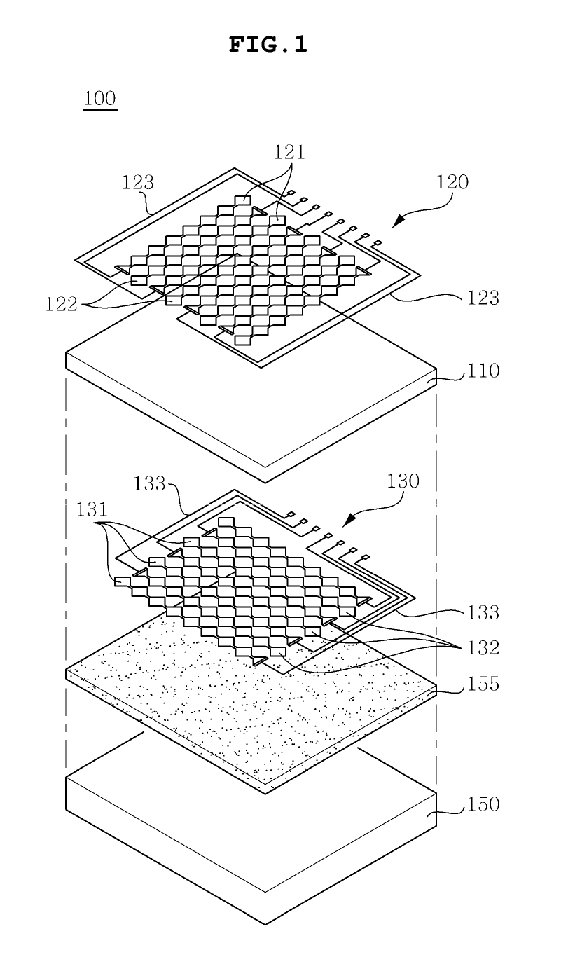

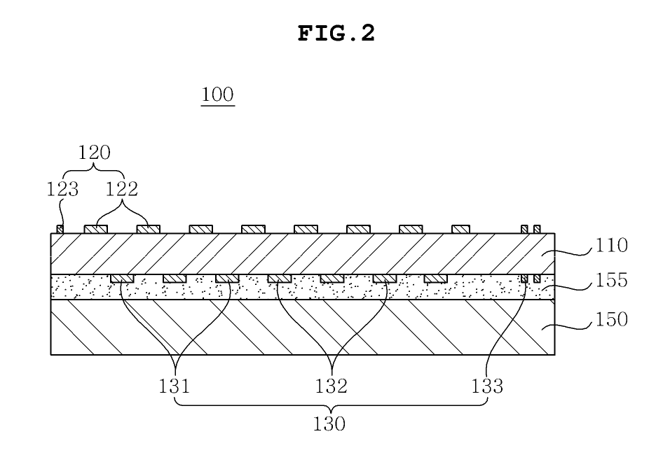

FIG. 1 is an exploded perspective view of a touch screen according to a first preferred embodiment of the present invention and FIG. 2 is a cross-sectional view of the touch screen according to the first preferred embodiment of the present invention.

As shown in FIGS. 1 and 2, a touch screen 100 according to a preferred embodiment of the present invention is configured to include a transparent substrate 110, a touch electrode 120 formed on one surface of the transparent substrate 110, a digitizer electrode 130 formed on the other surface of the transparent substrate 110, and an image display device 150 provided in the other surface direction of the transparent substrate 110.

Referring to FIGS. 1 and 2, the transparent substrate 110 serves to provide a region in which the touch electrode 120 and the digitizer electrode 130 are formed.

Here, the transparent substrate 110 needs to have support force capable of supporting the touch electrode 120 and the digitizer electrode 130 and transparency capable of allowing a user to recognize an image provided from the image display device 150. In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like, but is not necessarily limited thereto.

Meanwhile, in order to activate both surfaces of the transparent substrate 110, it is preferable to perform high frequency treatment or primer treatment. An adhesion between the transparent substrate 110 and the touch electrode 120 and the digitizer electrode 130 may be improved by activating both surfaces of the transparent substrate 110.

Referring to FIGS. 1 and 2, the touch electrode 120 is formed on one surface of the transparent substrate 110 and the digitizer electrode 130 is formed on the other surface of the transparent substrate 110, such that the touch electrode 120 faces the digitizer electrode 130 based on the transparent substrate 110.

First, the touch electrode 120 is configured to include first electrode patterns 121 and second electrode patterns 122. In this case, the first electrode patterns 121 and the second electrode patterns 122 may be formed so as to vertically intersect each other.

However, a shape of the first electrode patterns 121 and the second electrode patterns 122 according to the preferred embodiment of the present invention is not necessarily limited thereto. For example, the first electrode patterns 121 and the second electrode patterns 122 may be formed in a parallel direction with each other.

The first electrode patterns 121 and the second electrode patterns 122 may serve to allow a controller to recognize touched coordinates by generating a signal when a user touches the digitizer pen.

Further, the digitizer electrode 130 is configured to include third electrode patterns 131 and fourth electrode patterns 132. In this case, the third electrode patterns 131 and the fourth electrode patterns 132 may be formed so as to vertically intersect each other.

However, a shape of the third electrode patterns 131 and the fourth electrode patterns 132 according to the preferred embodiment of the present invention is not necessarily limited thereto. For example, the third electrode patterns 131 and the fourth electrode patterns 132 are formed in parallel with each other but may be formed in parallel with each other.

The third electrode patterns 131 and the fourth electrode patterns 132 may serve to allow a controller to recognize coordinates at which the digitizer pen is touched by generating a signal when a user touches the digitizer pen.

Further, the touch electrode 120 may be made of any one of metal mesh, conductive polymer, and metal oxide.

First, the conductive polymer has excellent flexibility and a simple coating process. Here, an example of the conductive polymer may include poly-3,4-ethylenedioxythiophene/polystyrenesulfonate (PEDOT/PSS), polyaniline, polyacetylene, or polyphenylenevinylene.

In addition, the metal oxide is made of indium-thin oxide.

Further, the touch electrode 120 may be formed by a dry process, a wet process, or a direct patterning process. Here, the dry process means sputtering, evaporation, or the like, the wet process means dip coating, spin coating, roll coating, spray coating, or the like, and the direct patterning process means screen printing, gravure printing, inkjet printing, or the like.

Further, the metal mesh may be formed in a mesh pattern by using copper (Cu), aluminum (Al), gold (Au), silver (Ag), titanium (Ti), palladium (Pd), chromium (Cr), or a combination thereof.

In this case, the touch electrode 120 may be formed by a plating process or an evaporation process. Meanwhile, when the touch electrode 120 is made of copper (Cu), the surface of the touch electrode 120 may be blackened. Here, the blackening means a process of precipitating Cu₂O or CuO by oxidizing the surface of the touch electrode 120, wherein the Cu₂O is brown and is thus referred to as brown oxide and the CuO is black and is thus referred to as black oxide. As described above, the surface of the touch electrode 120 is blackened to prevent light from being reflected, thereby making it possible to improve visibility of the touch screen 100.

Further, a line width of the touch electrode 120 is set to be 7 μm or less and a pitch thereof is set to be 900 μm or less, thereby making it possible to improve visibility. However, the line width and the pitch of the touch electrode 120 according to the first preferred embodiment of the present invention are not limited thereto.

Meanwhile, the touch electrode 120 may also be made of metal silver formed by exposing and developing a silver salt emulsion layer, in addition to the above-mentioned metals.

Further, the digitizer electrode 130 may be made of the same material as the touch electrode 120, but the material of the digitizer electrode 130 according to the preferred embodiment of the present invention is not necessarily limited thereto.

Referring to FIGS. 1 and 2, the image display device 150 serves to output an image and is provided in the other surface direction of the transparent substrate 110.

Here, the image display device 150 includes a liquid crystal display device (LCD), a plasma display panel (PDP), an electroluminescence (EL), a cathode ray tube (CRT), or the like.

Further, the image display device 150 may be bonded to the other surface of the transparent substrate 110 by an optical transparent adhesive (OCA) 155.

In addition, referring to FIGS. 1 and 2, the touch electrode 120 is configured to include touch electrode wirings 123 receiving electrical signals from the touch electrode 120.

In this case, edges of the first electrode patterns 121 and the second electrode patterns 122 are provided with touch electrode wirings 123 to receive the electrical signals from the first and second electrode patterns 121 and 122.

In addition, referring to FIGS. 1 and 2, the digitizer electrode 130 is configured to include digitizer electrode wirings 133.

In this case, edges of the third electrode patterns 131 and the fourth electrode patterns 132 are provided with the digitizer electrode wirings 133 to receive the electrical signals from the third and fourth electrode patterns 131 and 132.

As a result, the touch screen 100 according to the first preferred embodiment of the present invention as described above is configured in a single module, including the touch electrode 120 and the digitizer electrode 130, thereby reducing the thickness of the touch screen 100 and the material costs.

In addition, the digitizer electrode is disposed on the front of the image display device 150 together with the touch electrode 120, thereby improving the sensitivity of the digitizer electrode.

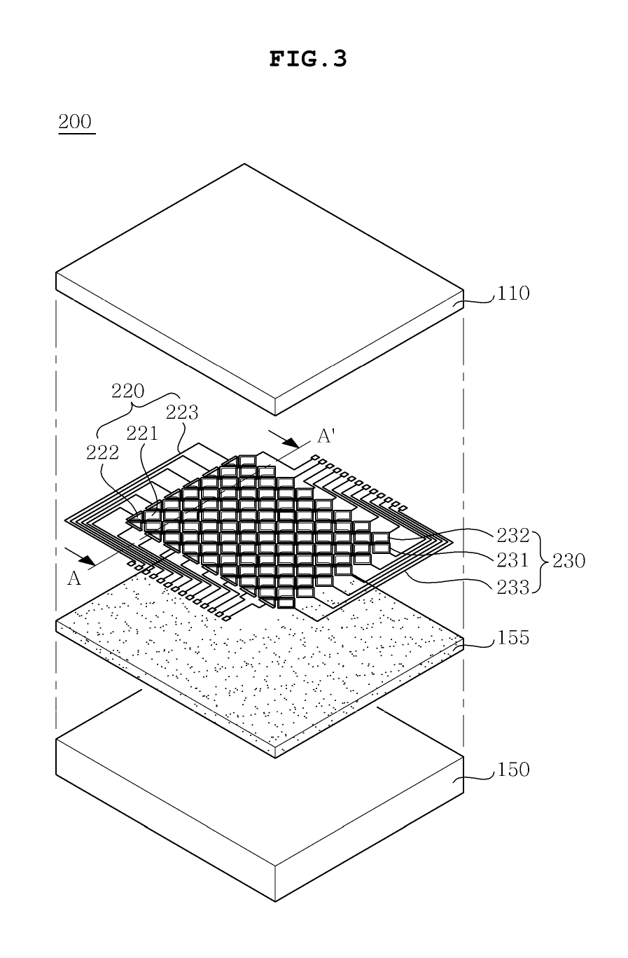

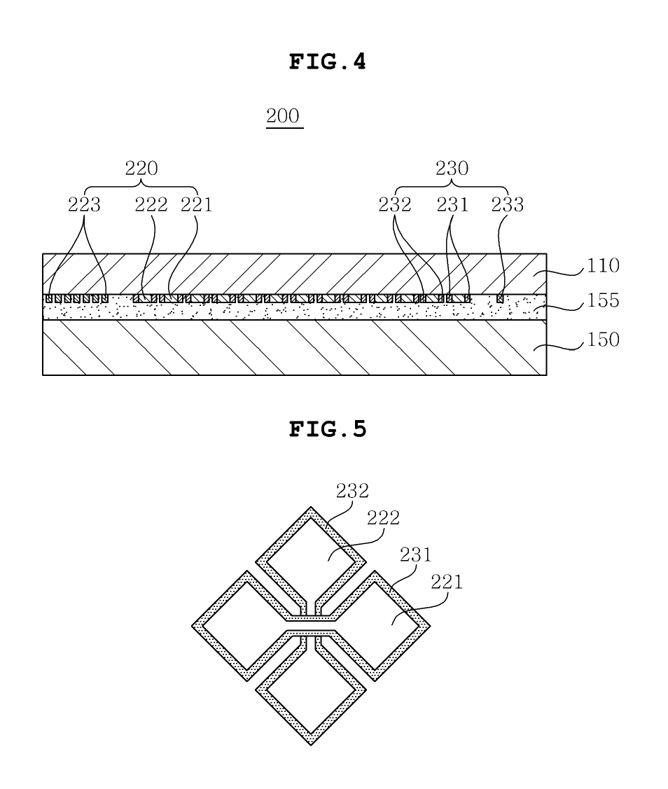

FIG. 3 is an exploded perspective view of a touch screen according to a second preferred embodiment of the present invention, FIG. 4 is a cross-sectional view of a touch screen according to a second preferred embodiment of the present invention, and FIG. 5 is a plan view showing a configuration example of a touch electrode and a digitizer electrode of the touch screen according to the second preferred embodiment of the present invention.

As shown in FIGS. 3 and 4, a touch screen 200 according to a preferred embodiment of the present invention is configured to include the transparent substrate 110, a touch electrode 220 formed on a first side of one surface of the transparent substrate 110, a digitizer electrode 230 formed on a second side of one surface of the transparent substrate 110, and the image display device 150 provided in the other surface direction of the transparent substrate 110.

When the touch screen 200 according to the second preferred embodiment of the present invention compares with the touch screen 100 according to the first preferred embodiment of the present invention, the second preference embodiment of the present invention is different from the first preferred embodiment the present invention in that the touch electrode 220 and the digitizer electrode 230 are formed on the transparent substrate 110 together. Therefore, the second preferred embodiment of the present invention briefly describes the repeated contents with the first preferred embodiment of the present invention and the difference thereof will be mainly described.

Referring to FIGS. 3 and 4, the transparent substrate 110 serves to provide a region in which the touch electrode 220 and the digitizer electrode 230 are formed. Here, the transparent substrate 110 needs to have a support force capable of supporting the touch electrode 220 and the digitizer electrode 230 and transparency capable of allowing a user to recognize an image provided from the image display device 150. In consideration of the support force and the transparency described above, the transparent substrate 110 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like, but is not necessarily limited thereto.

Meanwhile, in order to activate one surface of the transparent substrate 110, it is preferable to perform high frequency treatment or primer treatment. An adhesion between the transparent substrate 110 and the touch electrode 220 and the digitizer electrode 230 may be improved by activating one surface of the transparent substrate 110.

Referring to FIGS. 3 to 5, the touch electrode 220 is formed on a first side of one surface of the transparent substrate 110 and the digitizer electrode 230 is formed on a second side of one surface of the transparent substrate 110, such that the touch electrode 120 faces the digitizer electrode 130 based on the transparent substrate 110.

Here, the touch electrode 220 is configured to include first electrode patterns 221 and second electrode patterns 222. In this case, the first electrode patterns 221 and the second electrode patterns 222 may be formed so as to vertically intersect each other.

However, a shape of the first electrode patterns 221 and the second electrode patterns 222 according to the preferred embodiment of the present invention is not necessarily limited thereto. For example, the first electrode patterns 221 and the second electrode patterns 222 may be formed in parallel with each other, but may be formed in a parallel direction with each other.

The first electrode patterns 221 and the second electrode patterns 222 may serve to allow a controller to recognize touched coordinates by generating a signal when a user touches the digitizer pen.

Further, the digitizer electrode 230 is configured to include third electrode patterns 231 and fourth electrode patterns 232. In this case, the third electrode patterns 231 and the fourth electrode patterns 232 may be formed so as to vertically intersect each other.

However, a shape of the third electrode patterns 231 and the fourth electrode patterns 232 according to the preferred embodiment of the present invention is not necessarily limited thereto. For example, the third electrode patterns 231 and the fourth electrode patterns 232 are formed in parallel with each other but may be formed in a parallel direction with each other.

In particular, the third electrode patterns 231 and the fourth electrode patterns 232 may be formed along edges of the first electrode patterns 221 and the second electrode patterns 222. As a result, the digitizer electrode 230 and the touch electrode 220 may be formed on the same layer by forming the digitizer electrode 230 at the edge of the touch electrode 220.

Therefore, the thickness of the touch screen 220 can be reduced and the material costs can be reduced.

The third electrode patterns 231 and the fourth electrode patterns 232 may serve to allow a controller to recognize coordinates at which the digitizer pen is touched by generating a signal when a user touches the digitizer pen.

Further, the touch electrode 220 may be made of any one of metal mesh, conductive polymer, and metal oxide.

First, the conductive polymer has excellent flexibility and a simple coating process. Here, an example of the conductive polymer may include poly-3,4-ethylenedioxythiophene/polystyrenesulfonate (PEDOT/PSS), polyaniline, polyacetylene, or polyphenylenevinylene.

In addition, the metal oxide is made of indium-thin oxide.

Further, the touch electrode 220 may be formed by a dry process, a wet process, or a direct patterning process. Here, the dry process means sputtering, evaporation, or the like, the wet process means dip coating, spin coating, roll coating, spray coating, or the like, and the direct patterning process means screen printing, gravure printing, inkjet printing, or the like.

Further, the metal mesh may be formed in a mesh pattern by using copper (Cu), aluminum (Al), gold (Au), silver (Ag), titanium (Ti), palladium (Pd), chromium (Cr), or a combination thereof.

In this case, the touch electrode 220 may be formed by a plating process or an evaporation process. Meanwhile, when the touch electrode 220 is made of copper (Cu), the surface of the touch electrode 220 may be blackened. Here, the blackening 220 means a process of precipitating Cu₂O or CuO by oxidizing the surface of the electrode pattern 110, wherein the Cu₂O is brown and is thus referred to as brown oxide and the CuO is black and is thus referred to as black oxide. As described above, the surface of the touch electrode 220 is blackened to prevent light from being reflected, thereby making it possible to improve visibility of the touch screen 200.

Further, the touch electrode 220 may also be made of metal silver formed by exposing and developing a silver salt emulsion layer, in addition to the above-mentioned metals.

Meanwhile, the digitizer electrode 230 may be made of the same material as the touch electrode 220, but the material of the digitizer electrode 230 according to the preferred embodiment of the present invention is not necessarily limited thereto.

Referring to FIGS. 3 and 4, the image display device 150 serves to output an image and is provided in the other surface direction of the transparent substrate 110.

Therefore, the touch electrode 220 and the digitizer electrode 230 are disposed on the front of the image display device 150, thereby making it possible to improve the sensitivity of the digitizer electrode 230.

Further, the touch screen is configured in the single module, including the touch electrode 220 and the digitizer electrode 230, thereby making it possible to reduce the thickness of the touch screen 200 and the material costs.

Meanwhile, the image display device 150 includes a liquid crystal display device (LCD), a plasma display panel (PDP), an electroluminescence (EL), a cathode ray tube (CRT), or the like. Further, the image display device 150 may be bonded to the other surface of the transparent substrate 110 by an optical transparent adhesive (OCA) 155.

In addition, referring to FIGS. 3 and 4, the touch electrode 220 is configured to include touch electrode wirings 223 receiving the electrical signals from the touch electrode 220.

In this case, edges of the first electrode patterns 221 and the second electrode patterns 222 are provided with touch electrode wirings 223 to receive the electrical signal from the first and second electrode patterns 221 and 222.

In addition, the digitizer electrode 230 is configured to include the digitizer electrode wirings 233.

In this case, edges of the third electrode patterns 231 and the fourth electrode patterns 232 are provided with the digitizer electrode wirings 233 to receive the electrical signals from the third and fourth electrode patterns 231 and 232.

The preferred embodiments of the present invention can reduce the thickness of the touch screen and save the material costs by configuring the touch electrode and the digitizer electrode in the single module.

Further, the preferred embodiments of the present invention can improve the sensitivity of the digitizer electrode by disposing the touch electrode and the digitizer electrode on the front of the image display device.

In addition, the preferred embodiments of the present invention can further reduce the thickness of the touch screen upon forming the touch electrode and the digitizer electrode on the single surface.

Although the preferred embodiments of the present invention have been disclosed for illustrative purposes, they are for specifically explaining the present invention and thus a touch screen according to the present invention is not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. A touch screen, comprising:
a transparent substrate;
a touch electrode formed on one surface of the transparent subs ate;
a digitizer electrode formed on the other surface of the transparent substrate; and
an image display device provided in the other surface direction of the transparent substrate.

2. The touch screen as set forth in claim 1, wherein the touch electrode includes first electrode patterns and second electrode patterns.

3. The touch screen as set forth in claim 1, wherein the digitizer electrode includes third electrode patterns and fourth electrode patterns.

4. The touch screen as set forth in claim 1, wherein the touch electrode is made of copper (Cu), aluminum (Al), gold (Au), silver (Ag), titanium (Ti), palladium (Pd), chromium (Cr), or a combination thereof.

5. The touch screen as set forth in claim 1, wherein the touch electrode is formed in a mesh form.

6. The touch screen as set forth in claim 1, wherein the touch electrode is made of poly-3,4-ethylenedioxythiophene/polystyrenesulfonate (PEDOT/PSS), polyaniline, polyacetylene, or polyphenylenevinylene.

7. The touch screen as set forth in claim 1, wherein the touch electrode is made of metal silver formed by exposing and developing a silver salt emulsion layer.

8. The touch screen as set forth in claim 1, wherein the touch electrode is made of indium-thin oxide.

9. A touch screen, comprising:
a transparent substrate;
a touch electrode formed on a first side of one surface of the transparent substrate;
a digitizer electrode formed on a second side of one surface of the transparent substrate; and
an image display device provided in the other surface direction of the transparent substrate.

10. The touch screen as set forth in claim 9, wherein the touch electrode includes first electrode patterns and second electrode patterns.

11. The touch screen as set forth in claim 10, wherein the digitizer electrode includes third electrode patterns and fourth electrode patterns.

12. The touch screen as set forth in claim 11, wherein the third electrode patterns and the fourth electrode patterns are each formed along edges of the first electrode patterns and the second electrode patterns.

13. The touch screen as set forth in claim 9, wherein the touch electrode is made of copper (Cu), aluminum (Al), gold (Au), silver (Ag), titanium (Ti), palladium (Pd), chromium (Cr), or a combination thereof.

14. The touch screen as set forth in claim 9, wherein the touch electrode is formed in a mesh form.

15. The touch screen as set forth in claim 9, wherein the touch electrode is made of poly-3,4-ethylenedioxythiophene/polystyrenesulfonate (PEDOT/PSS), polyaniline, polyacetylene, or polyphenylenevinylene.

16. The touch screen as set forth in claim 9, wherein the touch electrode is made of metal silver formed by exposing and developing a silver salt emulsion layer.

17. The touch screen as set forth in claim 9, wherein the touch electrode is made of indium-thin oxide.
